(19) United States
(12) Patent Application Publication
(10) Pub. No.: US 2007/0194996 A1
(43) Pub. Date: Aug. 23, 2007

(54) Chip Antenna Mounting Apparatus

(75) Inventors: Chuan-Lin Hu, Sijhih City (TW); Yu-Wei Chen, Sijhih City (TW); Chang-Lun Liao, Sijhih City (TW); Shun-Tian Lin, Taipei City (TW); Chang-Fa Yang, Taipei City (TW); Yen-Ming Chen, Taipei City (TW); Chao-Wei Wang, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Chant Sincere Co., Ltd., Hsi Chih City (TW)

(21) Appl. No.: 11/564,033

(22) Filed: Nov. 28, 2006

(30) Foreign Application Priority Data
Feb. 20, 2006 (TW) 95105666

(51) Int. Cl. H01Q 1/24

(52) U.S. Cl. 343/702; 343/700 MS

(57) ABSTRACT

A connection apparatus for a chip antenna includes a connection base and at least one chip slot. The connection base is disposed on a circuit board and connects to the electronic components of the circuit board via a connection wire. The chip slot is disposed on the connection base for inserting the chip antenna. Thus, the chip antenna is connected to the electronic components of the circuit board via the connection wire.

### RELATED APPLICATIONS

The present application is based on, and claims priority from, Taiwan Application Serial Number 95105666, filed Feb. 20, 2006, the disclosure of which is hereby incorporated by reference herein in its entirety.

### BACKGROUND

1. Field of Invention

The present invention relates to a chip antenna mounting apparatus. More particularly, the present invention relates to an apparatus that provides a connection to a chip antenna on a circuit board.

2. Description of Related Art

There is rapid growth in the wireless communication sector, for example, cell phones, computer and Wi-Fi network, which utilize the wireless communication to transmit and receive signals. Wireless communication uses a signal transceiver and a signal transciever antenna transmit and receive signals. The traditional antenna, for example, rod antenna, yagi antenna and dish antenna, cannot satisfy the current trends which require low cost and compliance with the requirements of light, thin, short and with small volume. Therefore, a chip antenna is developed to comply the requirements of the foregoing objectives.

The connection between the chip antenna and the circuit board is the critical step in the antenna manufacturing technique. The conventional method uses electrical conducting glue, direct molding or soldering to attach the chip to the PCB for connectivity. The soldering, in general, is the most common method to connect the chip antenna and the circuit board. The soldering method can obtain a good connection result if there is good control on the soldering current. However, there are many factors that need to be taken into consideration in the manufacturing process (for example, the defects causes by the solder skip and dry joint etc).

In other aspects, the molding, binding and soldering method for connecting the chip antenna and the circuit board usually requires an empty area on the circuit board. The antenna radiation pattern cannot be adjusted accordingly due to the fixed position of the antenna. Further, the soldering method is difficult to solder the chip antenna vertical to the circuit board and it lacks stable support which results in an unreliable connection.

A planar Inverted-F Antenna (PIFA) is adopted to overcome the volume of the antenna. However, the PIFA still requires a large empty space on the circuit board.

For the forgoing reasons, there is a need for an improved connection method between a chip antenna and a circuit board to solve the support problem when using the soldering method. Moreover, the radiation pattern of the chip antenna can be adjusted according to the requirements, and can be to reduce the empty space needed in the circuit board to further achieve the smaller volume when connecting the chip antenna on the circuit board.

### SUMMARY

It is therefore an objective of the present invention to provide a stable support for a chip antenna mounting apparatus to connect a chip antenna and a circuit board to form a required antenna radiation pattern, and reduce empty space on the circuit board to further achieve smaller volume when connecting the chip antenna on the circuit board.

In accordance with the foregoing objectives of the present invention, a chip antenna mounting apparatus includes a connection base and at least one chip slot. The connection base is disposed on a circuit board and has a connection wire to connect the electronic components of the circuit board. The chip slot is disposed on the connection base. The chip antenna is inserted into the chip slot and connects with the electronic components of the circuit board via the connection wire.

The other objectives of the present invention are to provide a connection apparatus on a circuit board to connect a chip antenna and to reduce the empty space required for the chip antenna. The connection apparatus utilizes a coupling effect between the circuit board and a ground area and adjusts the angle between the chip antenna and the surface of the connection base to achieve the required radiation pattern.

In accordance with the preferred embodiment of the present invention, the connection apparatus on a circuit board for connecting a chip antenna includes a circuit board, a chip antenna, a connection base and at least one chip slot. The connection base is disposed on the circuit board and has a connection wire to connect the electronic components of the circuit board. The chip slot is disposed on the connection base. The chip antenna is inserted into the chip slot and connects with the electronic components of the circuit board via the connection wire. The circuit board further includes a ground area located near one side or the other side of the corresponding chip antenna.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A is a lateral view of one preferred embodiment for the present invention;

FIG. 1B is a lateral view of another preferred embodiment for the present invention;

FIG. 1C is a lateral view of another preferred embodiment for the present invention;

FIG. 2A˜2I are the antenna pattern graphs illustrated when a center frequency is 2.4 GHz for the chip antenna of FIG. 1B;

FIG. 3A˜3I are the antenna pattern graphs illustrated when a center frequency is 5 GHz for the chip antenna of FIG. 1B;

FIG. 4 illustrates a graph of return loss versus frequency response of chip antenna of FIG. 1B;

FIG. 5A is a graph of return loss versus frequency response when there is a 45 degree angle between a chip antenna and a connection base, and a circuit board contains/does not contain a ground area of the chip antenna mounting apparatus of FIG. 1B;

FIG. 5B is a graph of return loss versus frequency response when there is a 90 degree angle between a chip antenna and a surface of a connection base, and a circuit board contains/does not contain a ground area of the chip antenna mounting apparatus of FIG. 1B;

FIG. 6A˜6C are the antenna pattern graphs when a chip antenna and a connection base have a 45 degree angle, a circuit board contains a ground area and the center frequency is 2.4 GHz of the chip antenna mounting apparatus of FIG. 1B; and

FIG. 7A˜7C are the antenna pattern graphs when a chip antenna and a connection base has a 90 degree angle, a circuit board contains a ground area and a center frequency is 2.4 GHz of the chip antenna mounting apparatus of FIG. 1B.

### DESCRIPTION OF THE PREFERRED EMBODIMENTS

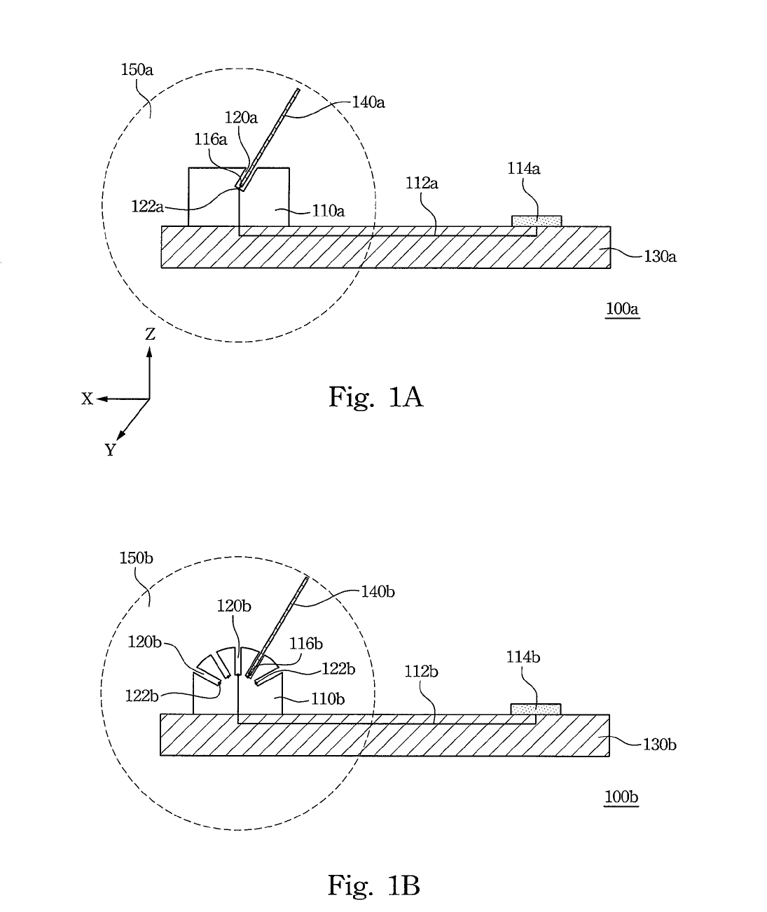

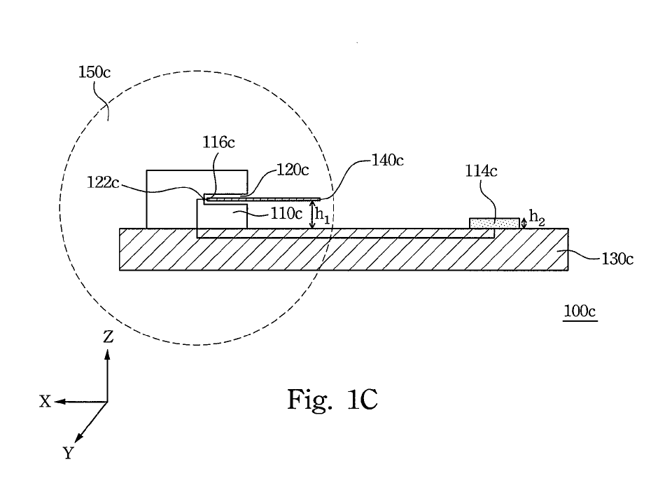

FIG. 1A illustrates a lateral view of a chip antenna mounting apparatus 150a of one preferred embodiment for the present invention. The chip antenna mounting apparatus 150a includes a connection base 110a, a connection wire 112a and at least a chip slot 120a. The connection base 110a is disposed on a circuit board 130a. The connection base 110a includes a connection wire 112a to connect the electronic components 114a of the circuit board 130a. At least one chip slot 120a is disposed on the connection base 110a to insert the chip antenna 140a. The chip antenna 140a is connected to the electronic components 114a of the circuit board 130a via the connection wire 112a.

In addition, the chip slot 120a has a connection point 122a to connect a feed-in point 116a of the chip antenna 140a for signal transmission. Generally, the feed-in point 116a of the chip antenna 140a may be a signal terminal of the chip antenna 140a or any part of the chip antenna 140a for signal transmission. Further, the position of the connection point 122a of the chip slot 120a is disposed accordingly to the feed-in point 116a of the chip antenna 140a. For example, the feed-in point 116a and the position of the connection point 122a are disposed respectively on the bottom or on the side of the chip antenna 140a and the chip slot 120a. Or the feed-in point 116a is disposed on both sides of the chip antenna 140a according to the connection point 122a. Alternatively, the connection point 122a is disposed on both sides of the chip slot 120a according to the feed-in point 116a.

Referring to FIG. 1A, the connection type of the connection point 122a of chip slot 120a can be designed according to the product needs, for example, edge connector, pin or other connection types. The foolproof device might be incorporated when designing the chip slot 120a to prevent the incorrect insertion of the chip antenna 140a.

Conventional techniques usually design the chip antenna disposed flat on the circuit board. This requires an empty area around the chip antenna on the circuit board to prevent the interference from metal or other components of the circuit board which affect the radiation pattern of the chip antenna. However, the preferred embodiment of the invention for the position of the chip antenna 140a is not disposed flat on the circuit board 130a and instead there is a separation distance between the chip antenna 140a and the circuit board 130a. Therefore, there is no need to leave a large empty space to prevent interference as in the conventional method. This shows the preferred embodiment can effectively reduce the needed space for the chip antenna 140a on the circuit board 130a. In another aspect, the chip antenna 140a is connected via the chip antenna mounting apparatus 150a to the circuit board 130a in a standing position and is separated from the circuit board 130a.

Consequently, the radiation pattern from the preferred embodiment is not easily influenced by the metal or other components of the circuit board 130a.

FIG. 1B illustrates a lateral view of a chip antenna mounting apparatus 150b of another preferred embodiment for the present invention. The chip antenna mounting apparatus 150b includes a connection base 110b, and a plurality of chip slots 120b. An angle exists between each of the chip slots 120b and a surface of the connection base 110b, wherein each of the angles is different. Therefore the chip antenna 140b can use different chip slots 120b according to the required radiation pattern. Further, each of the chip slots 120b has a connection point 122b to provide the connection with a feed-in point of the chip antenna 140b for signal transmission.

Please refer to FIG. 1A and FIG. 1B, the chip antenna mounting apparatus 150a/150b further comprise an adjustable knob (not shown) to adjust an angle of the chip slot(s) 120a/120b to a surface of the connection base 110a/110b. The chip slot(s) 120a/120b having the adjustable knob can be seen as an adjustable chip slot, which is capable of selectively adjusting the angle between the chip slot(s) 120a/120b and the surface of the connection base 110a/110b.

Moreover, the chip slot(s) 120a/120b disposed on the connection base 110a/110b is a fixed or a pluggable chip slot. For example, the fixed chip slot fixes the chip antenna on the connection base 110a/110b directly. The pluggable chip slot can be simply and easily plugged in and pulled out from the connection base 110a/110b and can be changed according to the requirement.

FIG. 1C illustrates a lateral view of a chip antenna mounting apparatus 150c of another preferred embodiment for the present invention. The position of the chip slot 120c is arranged to be above the electronic components of the circuit board 130c. Therefore, the height h1 of the chip antenna 140c placed on the circuit board 130c is higher than the height h2 of the electronic components 114c placed on the circuit board 130c. The interference from the metal and the electronic components of the circuit board 130c for the radiation pattern of the chip antenna 140c is reduced because the chip antenna 140c is above the electronic components on the circuit board 130c. Therefore there is no need to have an empty area to prevent interference from electronic components on the circuit board 130c. Further, there is a ground area (not shown) on the circuit board 130c corresponding to the chip antenna 140c for the coupling effect between the chip antenna 140c and the ground area.

In another aspect, the present invention can be seemed as a disclosure of an apparatus having a chip antenna 100a. Refer to FIG. 1A, the apparatus having the chip antenna 100a includes a connection base 110a, a connection wire 112a, a chip slot 120a, a circuit board 130a and a chip antenna 140a. The connection base 110a is disposed on the circuit board 130a. The connection base 110a has a connection wire 112a to connect the electronic components 114a of the circuit board 130a. The chip slot 120a is disposed on the connection base 110a so the chip antenna 140a can be inserted in the chip slot 120a. The chip antenna 140a is connected to the components 114a of the circuit board 130a via the connection wire 112a.

In another aspect, the present invention can be seen as a disclosure of an apparatus having a chip antenna 100b. Please refer to FIG. 1B, the apparatus having the chip antenna 100b includes a connection base 110b, a connection wire 112b, at least one chip slot 120a, a circuit board 130b and a chip antenna 140b. The connection base 110b is disposed on the circuit board 130b. The connection base 110b has the connection wire 112b to connect the electronic components 114b of the circuit board 130b. The chip slot 120b is disposed on the connection base 110b so the chip antenna 140b can be inserted into the chip slot 120. The chip antenna 140b is connected to the components 114b of the circuit board 130b via the connection wire 112b.

Please refer to FIG. 1A and FIG. 1B, the connection structure of the connection base 110a, 110b, chip slot(s) 120a, 120b, circuit board 130a, 130b and chip antenna 140a, 140b are described above in the apparatus with the chip antenna 150a and 150b.

The following section describes the relationship between the angle α and the antenna pattern when the chip antenna 140b on the apparatus 100b has a center frequency of 2.4 GHz. In the preferred embodiment in FIG. 1b there is an angle α (for example, 0 degree, 45 degrees or 90 degrees) between the chip antenna 120b and the surface of the connection base 110b. The antenna pattern formed by the angle α (for example, 0 degree, 45 degrees or 90 degrees) of the chip antenna 140b on plane XY, XZ and YZ plane is explained below.

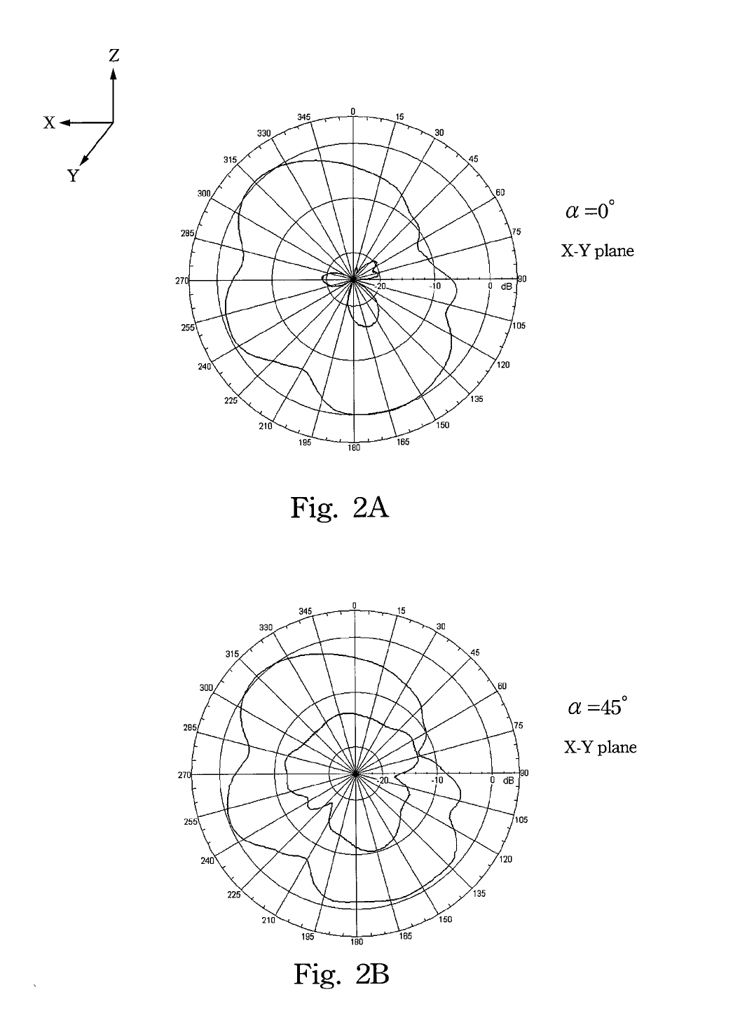

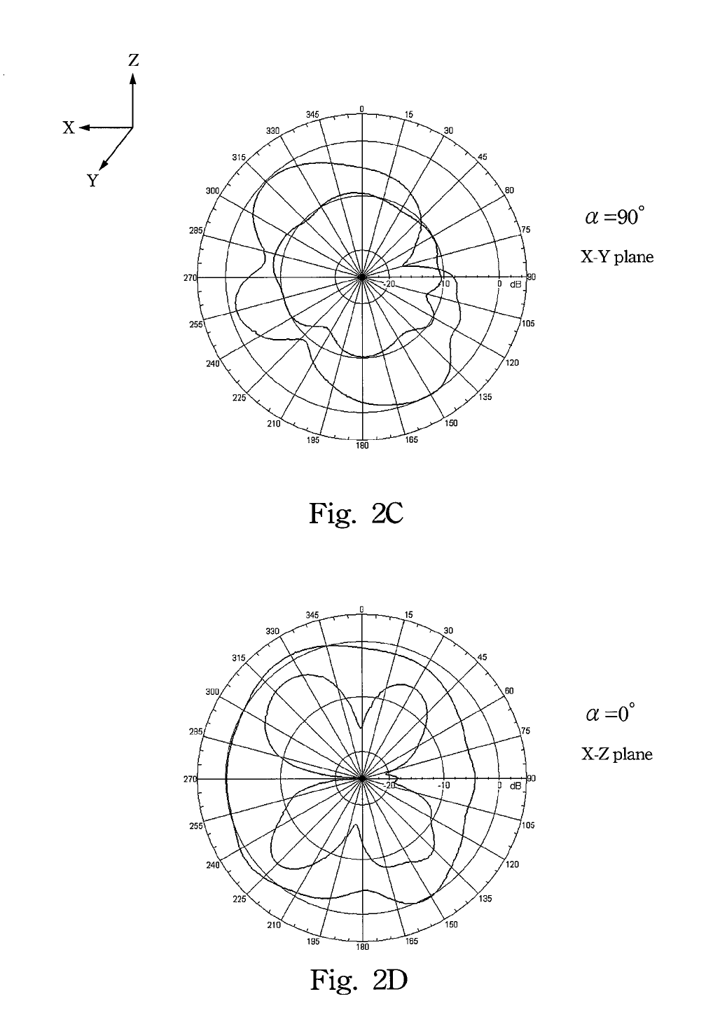

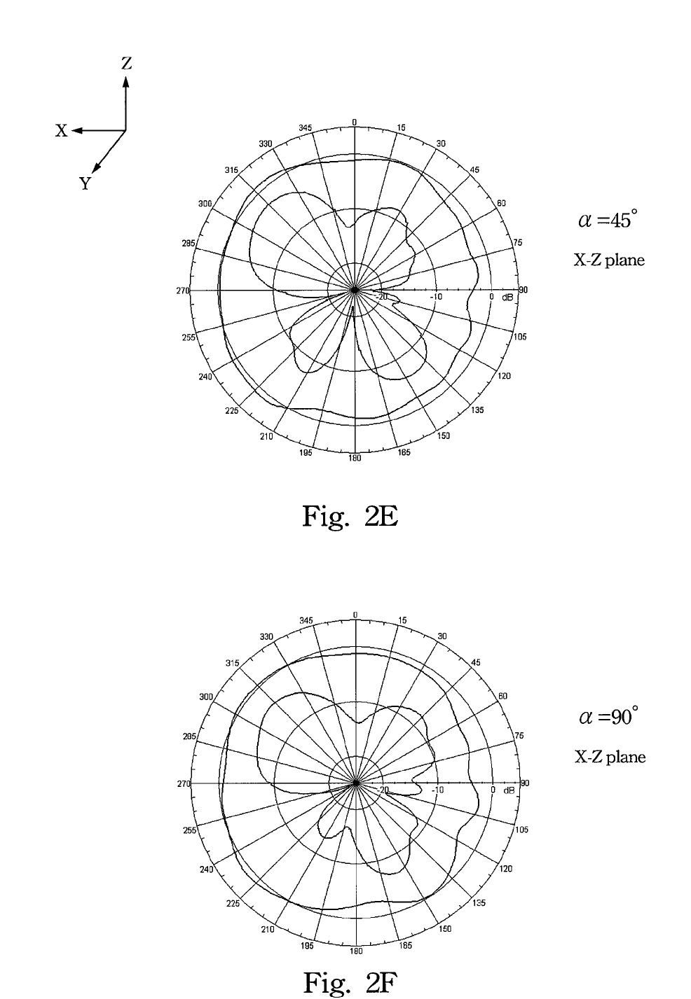

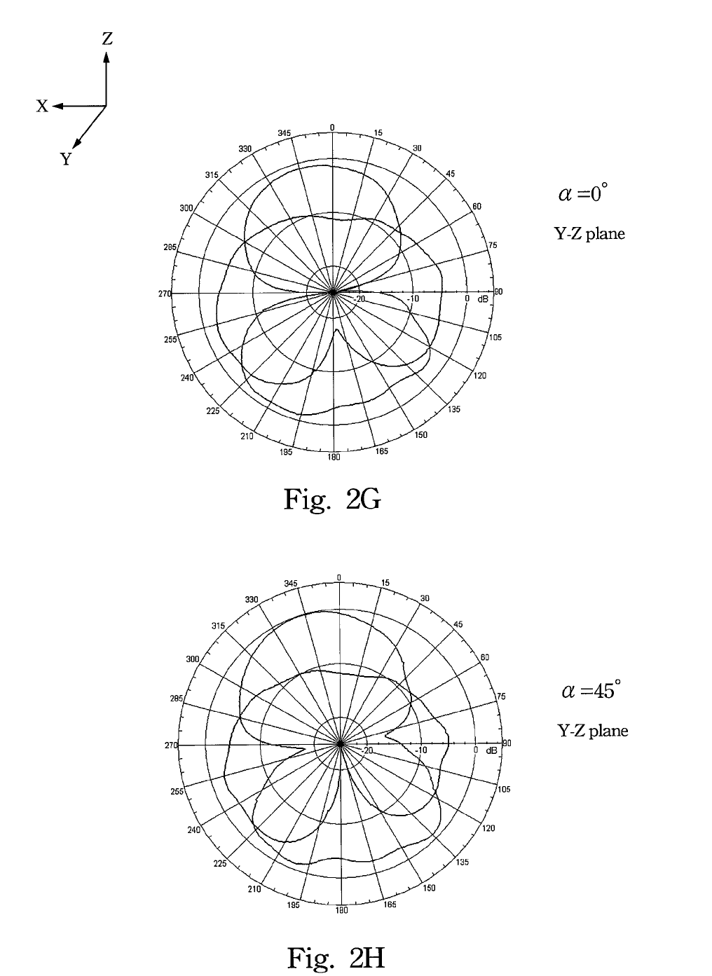

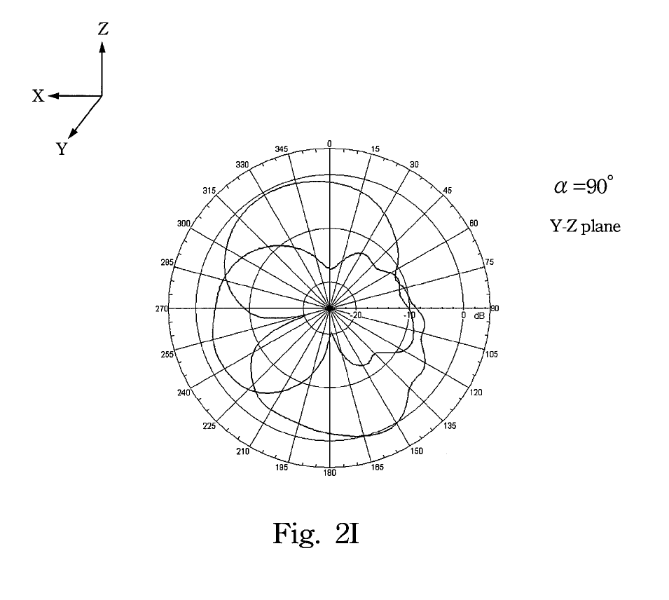

FIG. 2A, FIG. 2B and FIG. 2C are the antenna pattern graphs for the X-Y plane when there is an angle α of 0 degree, 45 degrees and 90 degrees respectively between the chip antenna 140b and the surface of the connection base 110b, and when the center frequency is 2.4 GHz for the chip antenna 140b of the preferred embodiment. FIG. 2D, FIG. 2E and FIG. 2F are the antenna pattern graphs for the X-Z plane when there is an angle α of 0 degree, 45 degrees and 90 degrees respectively between the chip antenna 140b and the surface of the connection base 110b, and when the center frequency is 2.4 GHz for the chip antenna 140b of the preferred embodiment. FIG. 2G, FIG. 2H and FIG. 2I are the antenna pattern graphs for the Y-Z plane when there is an angle α of 0 degree, 45 degrees and 90 degrees respectively between the chip antenna 140b and the surface of the connection base 110b, and when the center frequency is 2.4 GHz for the chip antenna 140b of the preferred embodiment.

FIG. 2A˜2I show the antenna pattern changes according to the angle αbetween the chip antenna 140b and the surface of the connection base 110b when the center frequency is 2.4 GHz for the chip antenna 140b of X-Y plane of the apparatus with a chip antenna 100b. Further, the chip antenna gain changes according to the angle α. The chip antenna gain is measured by dBi to indicate the ability to receive and transmit the signal in a particular direction for the chip antenna 140b. The higher the chip antenna gain, the better the cover range for radio wave.

FIG. 2A˜2C (X-Y plane) shows the chip antenna gain is 0.44 dBi, 0.41 dBi and −0.01 dBi when the angle α between the chip antenna 140b and the surface of the connection base 110b is 0 degree, 45 degrees and 90 degrees respectively. FIG. 2D˜2F (X-Z plane) shows the chip antenna gain is 1.12 dBi, 1.07 dBi and 1.03 dBi when the angel a between the chip antenna 140b and the surface of the connection base 110b is 0 degree, 45 degrees and 90 degrees respectively. FIG. 2G˜2I (Y-Z plane) shows the chip antenna gain is −1.04 dBi, −0.09 dBi and 0.35 dBi when the angel a between the chip antenna 140b and the connection base 110b is 0 degree, 45 degrees and 90 degrees respectively. Therefore, the required antenna pattern and the ideal cover range of the radio wave can be achieved by changing the angel a between the chip antenna 140b and the connection base 110b according to the requirement of the product.

The following describes the relationship between the antenna pattern and the angle α when the center frequency of the chip antenna 140b is 5 GHz for the chip antenna apparatus 100b, and refer to FIG. 1.

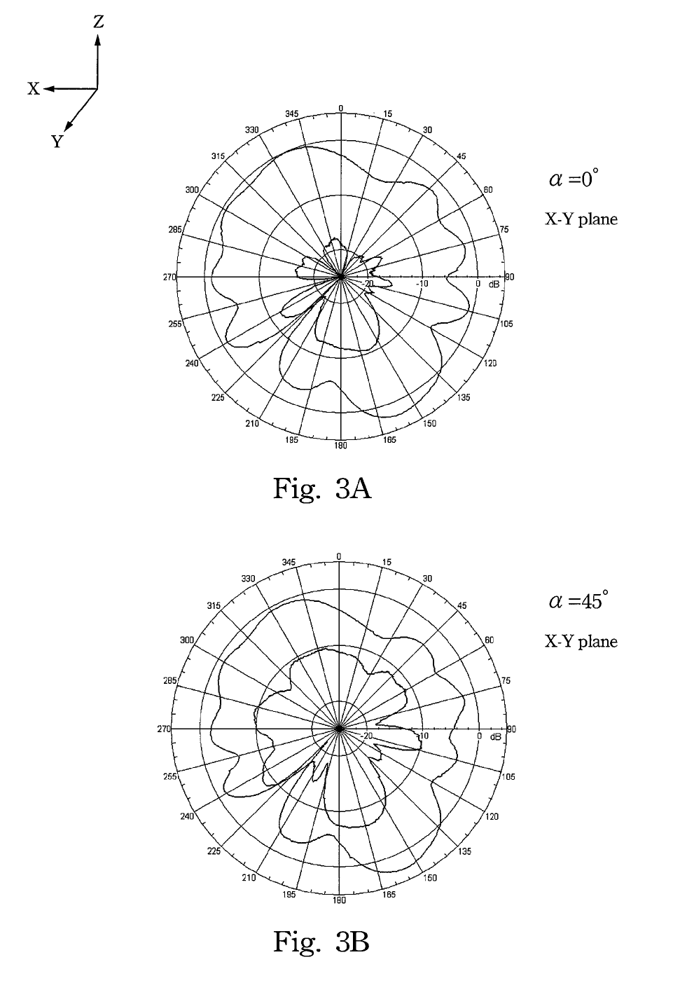

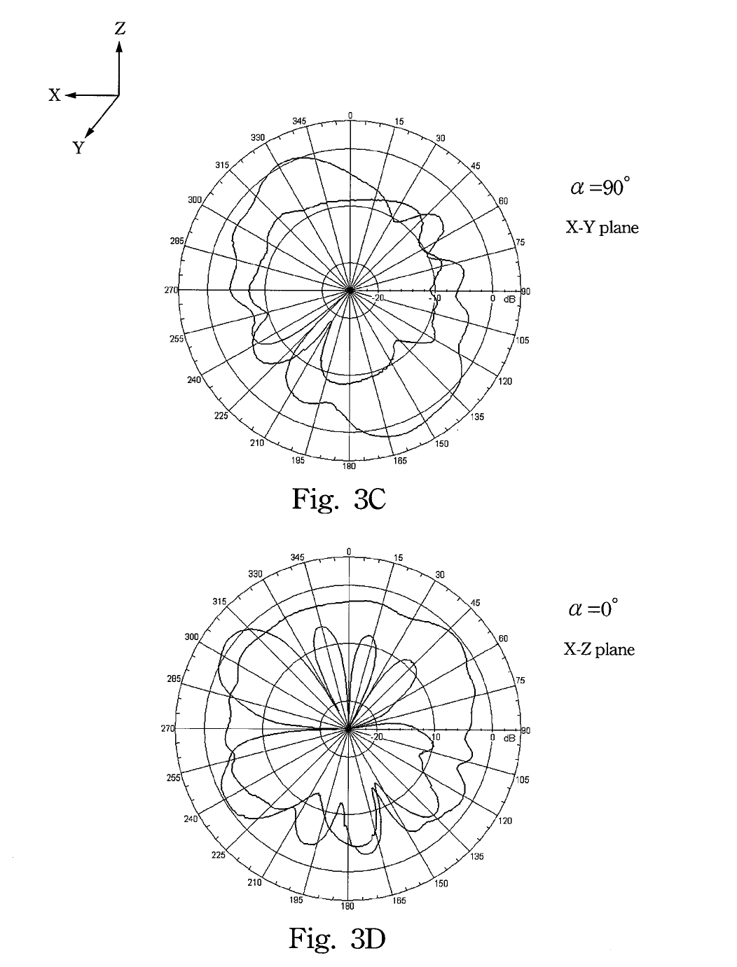

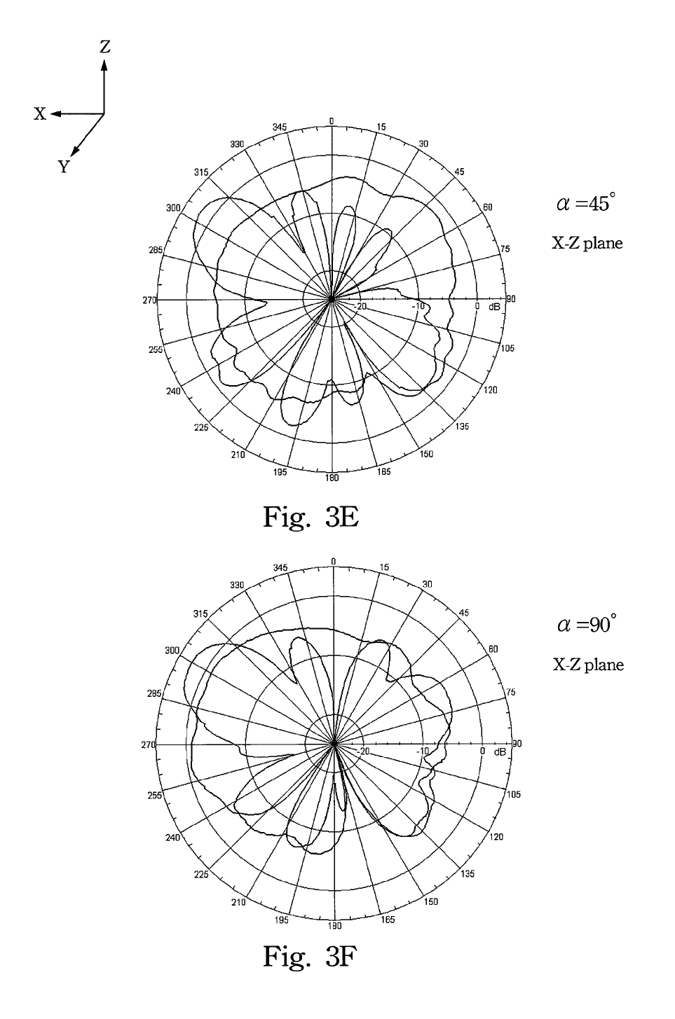

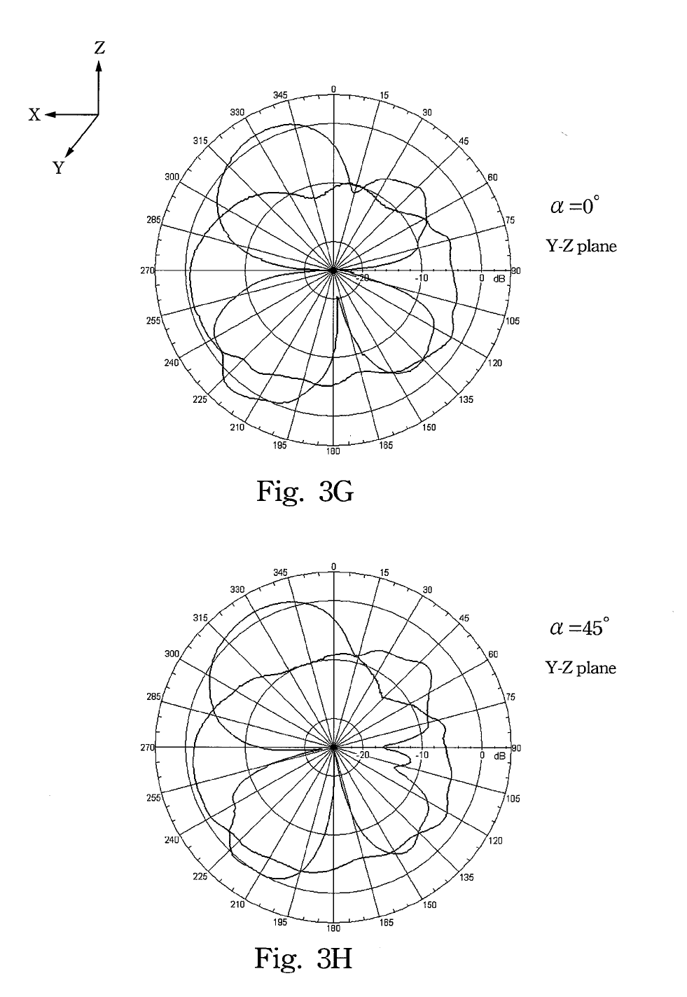

FIG. 3A, FIG. 3B and FIG. 3C are the antenna pattern graphs for the X-Y plane when there is an angle α of 0 degree, 45 degrees and 90 degrees respectively between the chip antenna 140b and the surface of the connection base 110b, and when the center frequency is 5.0 GHz of the chip antenna 140b of the preferred embodiment. FIG. 3D, FIG. 3E and FIG. 3F are the antenna pattern graphs for the X-Z plane when there is an angle α of 0 degree, 45 degrees and 90 degrees respectively between the chip antenna 140b and the surface of the connection base 110b, and when the center frequency is 5.0 GHz of the chip antenna 140b of the preferred embodiment. FIG. 3G, FIG. 3H and FIG. 3I are the antenna pattern graphs for the Y-Z plane when there is an angle α of 0 degree, 45 degrees and 90 degrees respectively between the chip antenna 140b and the surface of the connection base 110b, and when the center frequency is 5.0 GHz of the chip antenna 140b of the preferred embodiment.

FIG. 3A˜3I show the antenna pattern changes according to the angle α between the chip antenna 140b and the surface of the connection base 110b when the center frequency is 5 GHz for the chip antenna 140b of XY plane of chip antenna connection device 100b. Further, the chip antenna gain changes according to the angle α.

FIG. 3A˜3C (X-Y plane) shows the chip antenna gain is 2.37 dBi, 2.78 dBi and 1.87 dBi when the angle α between the chip antenna 140b and the surface of the connection base 110b is 0 degree, 45 degrees and 90 degrees respectively. FIG. 3D˜3F (X-Z plane) shows the chip antenna gain is 1.02 dBi, 2.16 dBi and 2.63 dBi when the angel a between the chip antenna 140b and the surface of the connection base 110b is 0 degree, 45 degrees and 90 degrees respectively. FIG. 3G˜3I (Y-Z plane) shows the chip antenna gain is 1.69 dBi, 1.72 dBi and 0.64 dBi when the angel a between the chip antenna 140b and the connection base 110b is 0 degree, 45 degree and 90 degree respectively. Therefore, the required antenna pattern and the ideal cover range for the radio wave can be achieved by changing the angel a between the chip antenna 140b and the connection base 110b according to the requirement of the product.

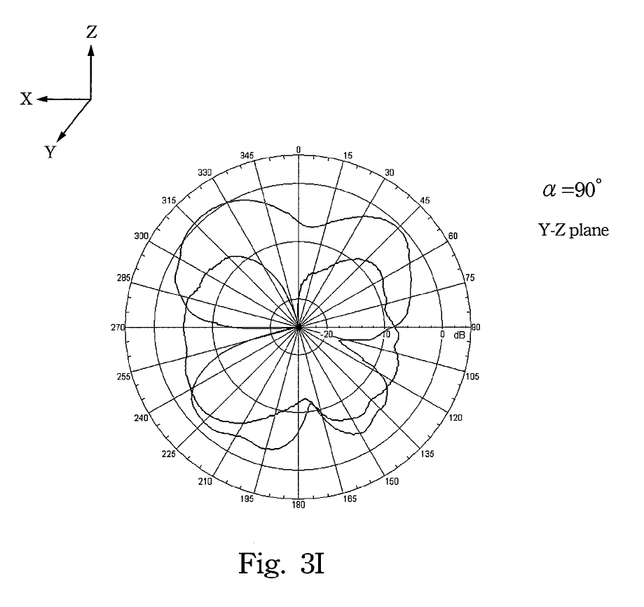

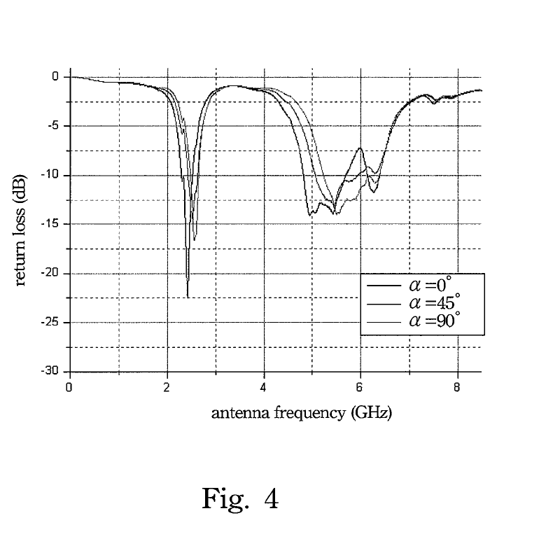

FIG. 4 illustrates a return loss versus frequency response graph of the chip antenna of FIG. 1B. The vertical axis is the return loss measured in dB and the horizontal axis is the frequency of the chip antenna 140b measured in GHz. FIG. 4 shows the same return loss and when the angle α is 0 degree, 45 degrees or 90 degrees respectively between the chip antenna 140b and the connection base 110b resulting in a shift of the frequency response of the chip antenna 140b. Therefore, the angel a of the chip antenna 140b and the connection base 110b can be adjusted accordingly to obtain the required frequency response of the chip antenna 140b.

Moreover, the circuit board 130b further includes a ground area (not shown) in the apparatus having the chip antenna 100b. The ground area is located near one side or the other side of the corresponding chip antenna 140b on the circuit board 130b for the coupling effect between the chip antenna 140b and the ground area.

The ground area is made from a metal, alloy or other electrically conductive material, for example, copper. The chip antenna includes a dielectric layer and a wire. The surface of the chip antenna 140b can be a dielectric material and the wire can be a metal, alloy or other electrically conductive material, for example, copper.

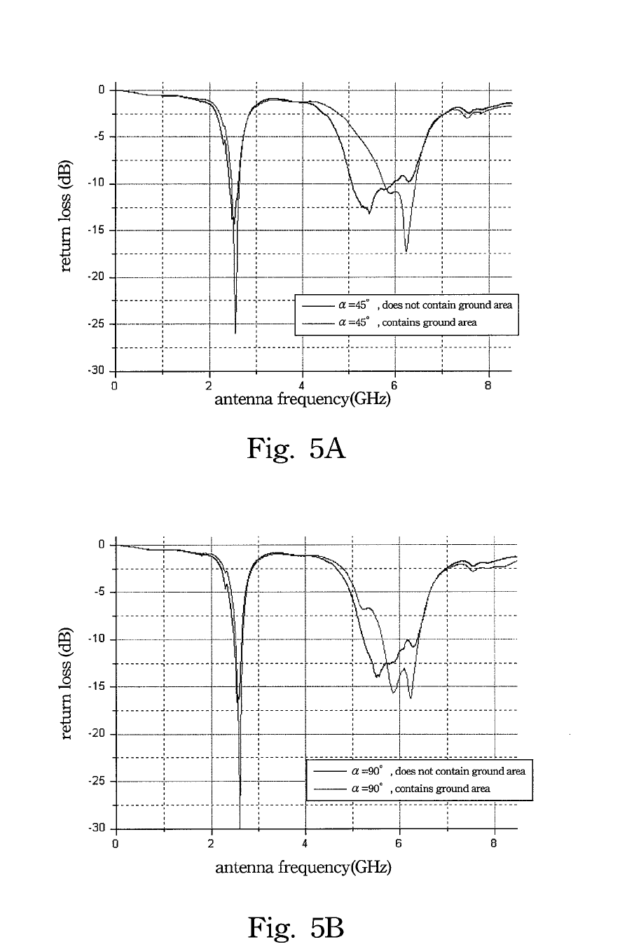

FIG. 5A is a return loss versus frequency response graph when there is a 45 degree angle between the chip antenna 140b and the surface of a connection base 110b, and the circuit board 130b contains/does not contain a ground area shown in FIG. 1B. Dielectric air exists in the angle α between the chip antenna 140b and the ground area of the circuit board 130b causing the coupling effect and consequently changes the frequency of the chip antenna 140b.

The coupling effect occurs even when the angle between the chip antenna 140b and the connection base 110b is 0 degree because the chip antenna 140b is higher than the ground area of the circuit board 130b, and a separation distance exists between the ground area and the chip antenna 140b. Therefore, the frequency of the chip antenna 140b of the preferred embodiment can be adjusted easily.

When the angle between the chip antenna 140b and the connection base 110b is 45 degrees and the center frequency is the same as the center frequency shown in FIG. 5A, the strength of the ground area return loss is larger than if there were no ground area on the circuit board 130b. Further, the frequency response of the chip antenna 140b with a ground area is shifted when compared to an antenna without a ground area on the circuit board 130b when the return loss is the same.

FIG. 5B is a return loss versus frequency response graph when there is a 90 degree angle between the chip antenna 140b and the surface of a connection base 110b, and the circuit board 130b contains/does not contain a ground area shown in FIG. 1B. When the angle between the chip antenna 140b and the connection base 110b is 90 degrees and the center frequency is the same as the center frequency shown in FIG. 5B, the strength of the ground area return loss is larger than if there were no ground area on the circuit board 130b. Further, the frequency response of the chip antenna 140b with a ground area is shifted when compared to an antenna without a ground area on the circuit board 130b when the return loss is the same. Therefore, the preferred embodiment of the present invention does not require a complicated design to adjust the frequency of the antenna chip 140b.

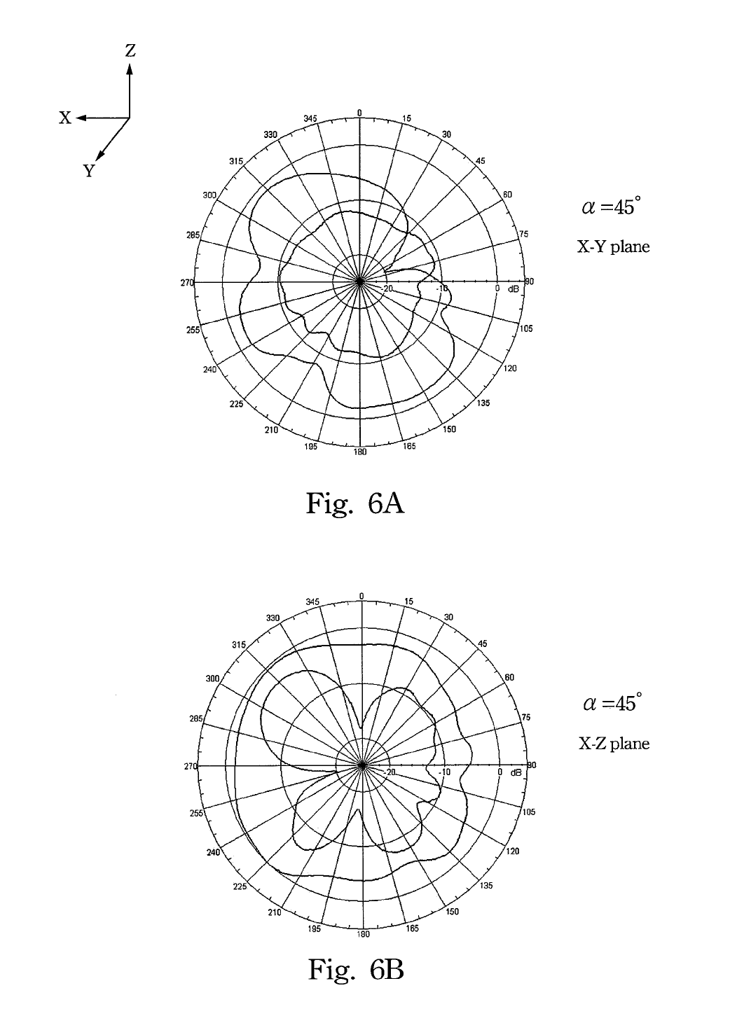

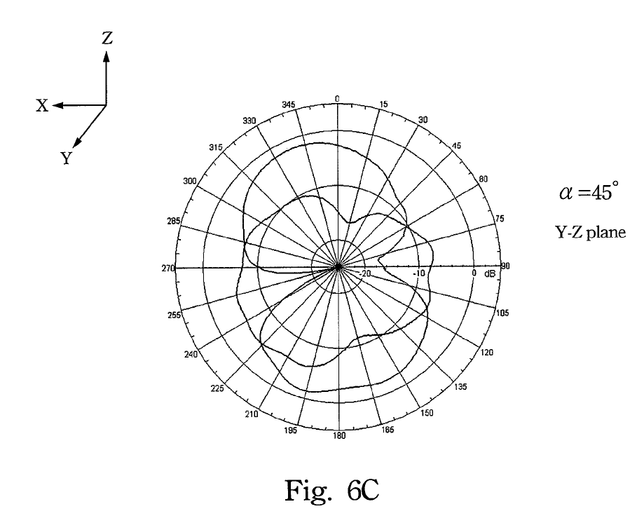

FIG. 6A, FIG. 6B and FIG. 6C are the antenna pattern graphs when the angle between the chip antenna 140b and the connection base 110b is 45 degrees (α), the circuit board 130b contains a ground area and the center frequency of the chip antenna 140b is 2.4 GHz. FIG. 6A show the antenna pattern graph for the X-Y plane, FIG. 6B shows the antenna pattern graph for the X-Z plane and FIG. 6C shows the antenna pattern graph for the Y-Z plane of the preferred embodiment of the present invention. Comparing FIG. 6A with FIG. 2A, FIG. 6B with FIG. 2E and FIG. 2C with FIG. 2H shows the different antenna patterns formed when the same center frequency is applied and the circuit board 130b contains/does not contain the ground area.

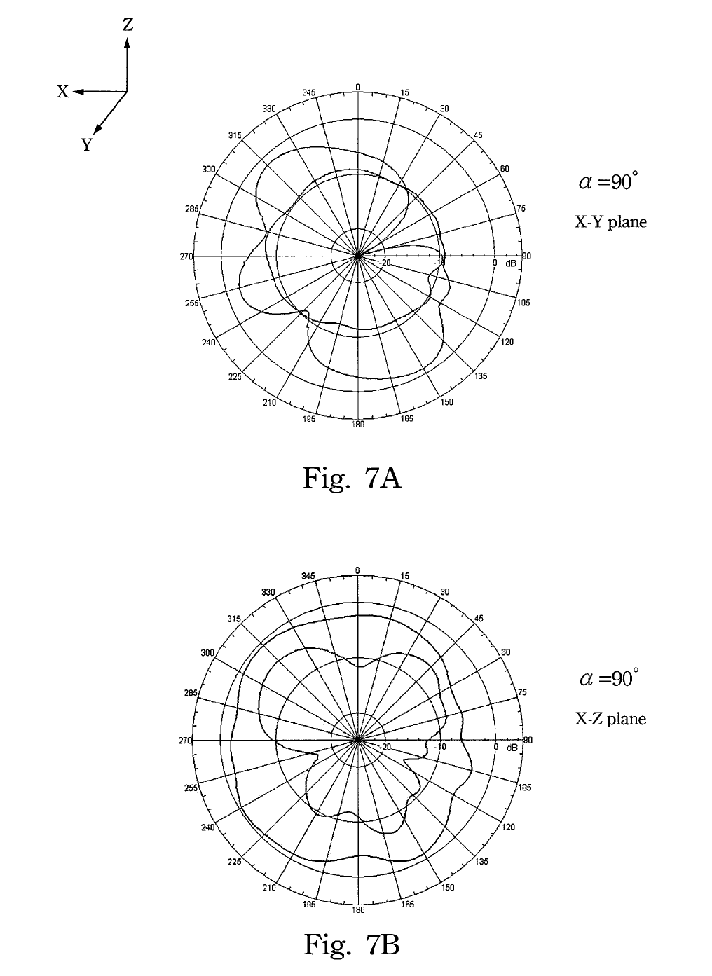

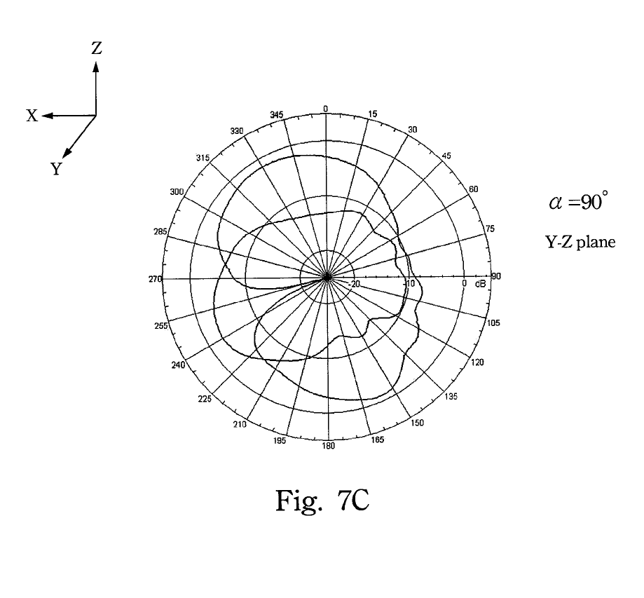

FIG. 7A, FIG. 7B and FIG. 7C are the antenna pattern graphs when the angle between the chip antenna 140b and the connection base 110b is 90 degrees (α), the circuit board 130b contains a ground area and the center frequency of the chip antenna 140b is 2.4 GHz. FIG. 7A show the antenna pattern graph for the X-Y plane, FIG. 7B shows the antenna pattern graph for the X-Z plane and FIG. 7C shows the antenna pattern graph for the Y-Z plane of the preferred embodiment of the present invention. Comparing FIG. 7A with FIG. 3B, FIG. 7B with FIG. 3E and FIG. 7C with FIG. 3H shows the different antenna patterns formed when the same center frequency is applied and the circuit board 130b contains/does not contain the ground area.

The preferred embodiment of the present invention provides a chip antenna mounting apparatus, includes a connection base and at least one chip slot. The chip antenna connection apparatus provides a chip antenna to easily adjust the chip antenna angle (the angle between the chip slot and the connection base) in order to obtain the required antenna pattern, and does not require a large empty space near the chip antenna on a circuit board. Therefore, the chip antenna connection apparatus can reduce the space needed for the chip antenna and any person skilled in the art to which it pertains can design a pluggable chip slot according to the requirement to further achieve the flexibility of the chip antenna.

In the other aspect, the present invention can be seemed as a disclosure of an apparatus having a chip antenna. The apparatus having the chip antenna adjusts an angle between a chip slot and a surface of a connection base according to the required antenna pattern, and adjusts the frequency response of the chip antenna. Further, the coupling effect between the ground area and the chip antenna is strengthened when the circuit board contains the ground area. Therefore, the preferred embodiment of the present invention reduces the design complexity of the chip antenna to further achieve the smaller size for the connection of the chip antenna and the circuit board.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A chip antenna mounting apparatus, comprising:
a connection base, disposed on a circuit board, wherein the connection base has a connection wire to connect the electronic components of the circuit board; and
at least one chip slot, disposed on the connection base, wherein the chip antenna is inserted into the chip slot and connected with the electronic components of the circuit board via the connection wire.

2. The chip antenna mounting apparatus of claim 1, wherein the chip slot has a connection point to connect a feed-in point of the chip antenna.

3. The chip antenna mounting apparatus of claim 1, wherein the chip slot and a surface of the connection base has an angle.

4. The chip antenna mounting apparatus of claim 3, wherein the angle corresponds to a radiation pattern of the chip antenna.

5. The chip antenna mounting apparatus of claim 3, wherein the angle corresponds to a frequency response of the chip antenna.

6. The chip antenna mounting apparatus of claim 1, wherein the chip slot is arranged to have a distance between the circuit board after the chip antenna is inserted.

7. The chip antenna mounting apparatus of claim 1, wherein the position of the chip slot is higher than the electronic components of the circuit board.

8. The chip antenna mounting apparatus of claim 1, wherein the connection base has a plurality of chip slots to provide a plurality of angles for the chip antenna.

9. The chip antenna mounting apparatus of claim 1, further comprises an adjustable knob to adjust an angle of the chip slot to a surface of the connection base.

10. The chip antenna mounting apparatus of claim 1, wherein the chip slot is a fixed chip slot or a pluggable chip slot.

11. An apparatus having a chip antenna, comprising:
a circuit board;
a chip antenna;
a connection base, disposed on the circuit board, wherein the connection base has a connection wire to connect the electronic components of the circuit board; and
at least one chip slot, disposed on the connection base, wherein the chip antenna is inserted into the chip slot and connects with the electronic components of the circuit board via the connection wire.

12. The apparatus having the chip antenna of claim 11, wherein the chip slot has a connection point to connect a feed-in point of the chip antenna.

13. The apparatus having the chip antenna of claim 11, wherein the chip slot and a surface of the connection base are at an angle to each other.

14. The apparatus having the chip antenna of claim 13, wherein the angle corresponds to a radiation pattern of the chip antenna.

15. The apparatus having the chip antenna of claim 13, wherein the angle corresponds to a frequency response of the chip antenna.

16. The apparatus having the chip antenna of claim 11, wherein the chip slot is arranged to have a distance between the circuit board after the chip antenna is inserted.

17. The apparatus having the chip antenna of claim 11, wherein the position of the chip slot is arranged to higher than the electronic components of the circuit board.

18. The apparatus having the chip antenna of claim 11, wherein the connection base has a plurality of chip slots to provide a plurality of angles for the chip antenna.

19. The apparatus having the chip antenna of claim 11, further comprises an adjustable knob to adjust the angle of the chip slot to a surface of the connection base.

20. The apparatus having the chip antenna of claim 11, wherein the chip slot is an adjustable chip slot, capable of adjusting an angle between the chip slot and a surface of the connection base.

21. The apparatus having the chip antenna of claim 11, wherein the chip slot is a fixed chip slot or a pluggable chip slot.

22. The apparatus having the chip antenna of claim 11, further comprises a ground area on the circuit board corresponding to the chip antenna for coupling effect between the chip antenna and the ground area.

23. The apparatus having the chip antenna of claim 22, wherein the ground area is located near one side or the other side of the corresponding chip antenna.

24. The apparatus having the chip antenna of claim 22, wherein the ground area is made of the metal, alloy or other electrically conductive material.
